(19) United States
(12) Patent Application Publication
(10) Pub. No.: US 2014/0300592 A1
(43) Pub. Date: Oct. 9, 2014

(54) DISPLAY DEVICE AND METHOD OF DRIVING THE SAME

(71) Applicant: Samsung Display Co., Ltd., Yongin-City (KR)

(72) Inventors: Jae-Hoon LEE, Yongin-City (KR); Baek-Woon LEE, Yongin-City (KR)

(73) Assignee: Samsung Display Co., Ltd., Yongin-City (KR)

(21) Appl. No.: 14/202,068

(22) Filed: Mar. 10, 2014

(30) Foreign Application Priority Data
Apr. 9, 2013 (KR) 10-2013-0038841

(51) Int. Cl. G09G 3/32

(52) U.S. Cl. CPC G09G 3/3258
USPC 345/212; 345/82

(57) ABSTRACT

Provided is a display device and a method of driving the same. The display device includes a display panel including a plurality of pixels, a data scaling unit scaling a data value of image data received from the outside based on a scaling ratio, a data driver providing a data signal to data lines connected to the plurality of pixels in response to the scaled data value, and a power unit that generates a driving voltage for emitting light from the plurality of pixels and changes the driving voltage in response to the scaled data value.

### CROSS-REFERENCE TO RELATED APPLICATION

Korean Patent Application No. 10-2013-0038841, filed on Apr. 9, 2013, in the Korean Intellectual Property Office, and entitled: “Display Device and Method of Driving the Same,” is incorporated by reference herein in its entirety.

### BACKGROUND

1. Field

Embodiments relate to a display device and a method of driving the same, and more particularly, to a display device of a digital driving type and a driving method of the same.

2. Description of the Related Art

An organic light-emitting display device (OLED), one of the newly introduced flat-panel displays, displays an image by using organic light-emitting diodes that generate light by recombination of electrons and holes. The OLED has fast response time and low power consumption.

A method of displaying gradation in an OLED may be divided into an analogue driving method and a digital driving method. In the analogue driving method, brightness of emitted light is controlled by changing a voltage applied to a light-emitting diode according to image data, and in the digital driving method, a light-emitting time of a light-emitting diode in each pixel region is controlled according to image data to display a gradation. When the analog driving method is used, a light-emitting diode and a driving thin film transistor that provides a voltage to the light-emitting diode need to be driven in a time-uniform manner. However, as time-uniformity may decrease due to deterioration of the driving thin film transistor and the light-emitting diode, displaying a gradation may be difficult as the voltage to brightness characteristics of display panel has a tendency of changing in time. On the other hand, when the digital driving method is used, an image may be uniformly displayed as the image is less affected by characteristic changes of the driving thin film transistor and the light-emitting diode.

### SUMMARY

One or more embodiments provide a display device including a display panel including a plurality of pixels; a data scaling unit scaling a data value of image data received from an outside based on a scaling ratio; a data driver providing a data signal to data lines connected to the plurality of pixels in response to the scaled data value; a power unit that generates a driving voltage for making the plurality of pixels emit light and that changes the driving voltage based on the scaling ratio.

A long range uniformity (LRU) of the display panel may be adjusted according to the scaling ratio.

The scaling ratio may be set based on the LRU of the display panel in a test period of the display device when the display panel displays the highest gradation.

The scaling ratio may be set to be less than 1 when the LRU is lower than a predetermined value.

The data scaling unit may down scale the data value of the image data received from the outside.

When the driving voltage is changed, the data scaling unit may scale the data value of the image data received from the outside to have the same brightness with a brightness that is set based on a level of the driving voltage before the brightness of light output from the display panel is changed.

The power unit may increase or decrease the driving voltage based on the scaling ratio.

The power unit may increase the driving voltage when the scaling ratio is less than 1.

The power unit may further increase the driving voltage as the scaling ratio is lower.

The display panel may be driven by a digital driving method, whereby a brightness of output light is changed depending on the driving voltage and a light-emitting time according to a data signal applied to each of the plurality of pixels.

Each of the plurality of pixels may include an organic light-emitting diode.

One or more embodiments provides a display device including an organic light-emitting display panel including a plurality of pixels including first pixels, second pixels, and third pixels emitting lights of different colors, and data lines and scan lines that are connected to the plurality of pixels; a scan driver sequentially providing a scan signal to the scan lines in each scan period of a plurality of sub-frames included in one frame; a data scaling unit that scales a data value of image data received from the outside based on a scaling ratio; a data driver providing a data signal that is generated by using the scaled data value to the data lines; a power unit generating a first driving voltage, a second driving voltage, and a third driving voltage that are each respectively provided to the first pixels, the second pixels, and the third pixels and adjusting at least one of the first driving voltage, the second driving voltage, and the third driving voltage based on the scaling ratio.

The data scaling unit may downscale the data value of the image data received from the outside, and the power unit increases at least one of the first, second, and third driving voltages based on the scaling ratio.

The power unit may further increase at least one of the first, second, and third driving voltage as the scaling ratio is lower.

The first pixels may be pixels that emit red light, the second pixels are pixels that emit green light, and the third pixels are pixels that emit blue light.

One or more embodiments provides a method of driving a display device comprising a plurality of pixels, the method including deriving a LRU of a display panel; determining a scaling ratio based on the LRU; adjusting a driving voltage according to the scaling ratio; scaling a data value of image data received from the outside based on the scaling ratio; and displaying a gradation corresponding to the scaled image data.

Deriving the LRU may include deriving the LRU based on a brightness data per pixel when a full white image of the highest brightness is displayed on the display panel.

Scaling the data value may include increasing the voltage value of the driving voltage as the scaling ratio decreases.

The plurality of pixels may include red pixels, green pixels, and blue pixels, wherein the driving voltage includes a first driving voltage applied to the red pixels, a second driving voltage applied to the green pixels, and a third driving voltage applied to the blue pixels, and wherein adjusting the driving voltage includes adjusting each of the first, second, and third driving voltages based on the scaling ratio.

The display panel may be driven by a digital driving method, whereby a brightness of output light is changed according to the driving voltage and an emission time in response to a data signal that is transmitted to each of the plurality of pixels.

### BRIEF DESCRIPTION OF THE DRAWINGS

Features will become apparent to those of skill in the art by describing in detail exemplary embodiments with reference to the attached drawings in which:

FIG. 1 illustrates a block diagram of a display device according to an embodiment;

FIG. 2 illustrates a circuit diagram of an example of one of the plurality of pixels of FIG. 1;

FIG. 3 illustrates a frame structural view of an example of a digital driving method;

FIG. 4 illustrates a graph for describing LRU of the display device of FIG. 1, the graph illustrating a relationship between a voltage and a current applied to pixels PX;

FIG. 5 illustrates a block diagram of a display device according to another embodiment;

FIG. 6 illustrates a block diagram of a brightness compensation system of a display device according to another embodiment;

FIG. 7 illustrates a flowchart for describing a driving method of a display device according to an embodiment;

FIG. 8 illustrates a graph for comparing the brightness characteristics of a display device according to an embodiment of the present invention and a conventional display device;

FIG. 9 illustrates a graph for comparing the color characteristics of a display device according to an embodiment of the present invention and a conventional display device; and

FIG. 10 illustrates products that may employ the display device according to embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

Detailed descriptions of commonly-used technologies related to the disclosure that may obscure embodiments may be omitted. In addition, though terms like a first and a second are used to describe various components, the components should not be limited by the terms. The terms may be used for the purpose of distinguishing one component from another.

The terms used herein are just for describing specific embodiments and are not intended to limit the present invention. The terms of a singular form may include plural forms unless clearly otherwise referred to in context. In this application, it should be understood that the terms “include,” “comprise,” “have”, “including,” “comprising,”, and “having” are intended to specify that there are features, figures, steps, operations, components, parts or their combinations represented in the specification and not to exclude that there may be one or more other features, figures, steps, operations, components, parts, or their combinations or that they may be added. The present invention will now be described more fully with reference to the accompanying drawings, in which exemplary embodiments of the invention are shown.

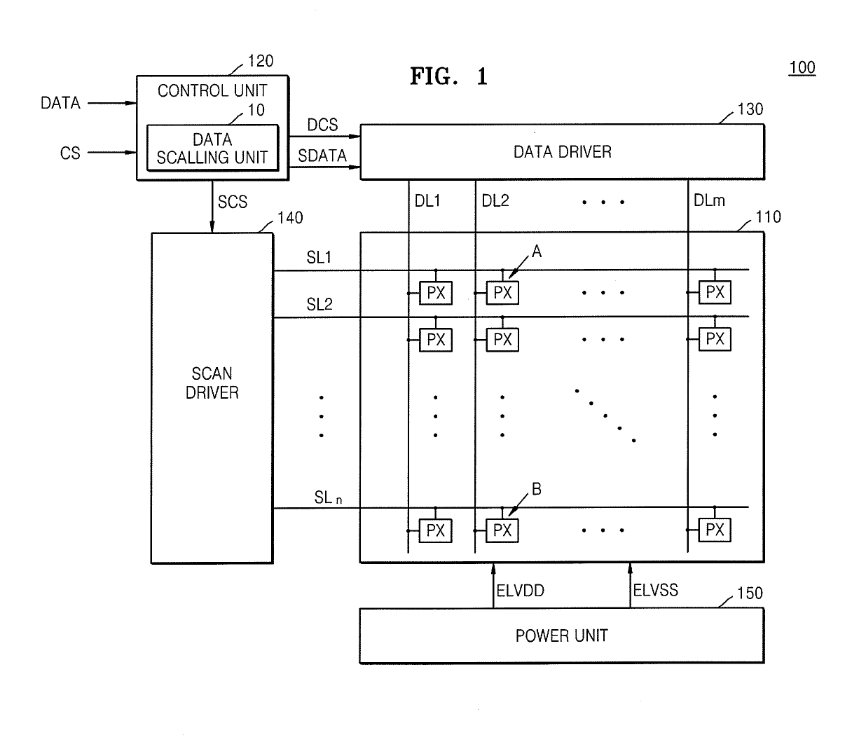

FIG. 1 illustrates a block diagram of a display device 100 according to an embodiment. The display device 100 may include a display panel 110 displaying an image, a scan driver 140 and a data driver 130 each respectively driving scan lines SL1 to SLn and data lines DL1 to DLm of the display panel 110, and a control unit 120 controlling the scan driver 140 and the data driver 130. Also, the display device 100 may further include a data scaling unit 10 scaling a data value of received image data DATA and a power unit 150 providing a driving voltage ELVDD and a common voltage ELVSS to the display panel 110. The common voltage ELVSS may have a lower value than the driving voltage ELVDD, e.g., may be a ground voltage.

The display panel 110 includes the plurality of scan lines SL1 to SLn transmitting scan signals in a row direction, the plurality of data lines DL1 to DLm arranged in columns, and a plurality of pixels PX arranged in a matrix at intersections of the scan lines SL1 to SLn and the data lines DL1 to DLm. The driving voltage ELVDD and the common voltage ELVSS are provided to the plurality of pixels PX from the power unit 150. Scan signals and data signals are respectively transmitted to the plurality of pixels PX through the scan lines SL1 to SLn and the data lines DL1 to DLm to operate the display panel 110.

The display panel 110 may be operated by a digital driving method. In the digital driving method, gradation is displayed by controlling the light-emitting time of each of the pixels PX according to the data signals. The pixels PX emit light in response to the driving voltage ELVDD and the common voltage ELVSS applied thereto, the light-emitting time is controlled by digital signals, and thus, gradation is displayed on the display panel 110. Even when the same gradation is displayed, a brightness may be different according to voltage values of the driving voltage ELVDD and the common voltage ELVSS applied to the pixels PX.

Meanwhile, each of the plurality of pixels PX included in the display panel 110 may display one color selected from a plurality of colors including red, green, and blue. Hereinafter, for convenience in description, the plurality of pixels PX are described assuming that they display one color selected from three primary colors, i.e., red, green, and blue.

The pixels PX may display one color selected from red, green, and blue, and pixels displaying red color, pixels displaying green color, and pixels displaying blue color may be sequentially and repeatedly arranged. In addition, a user may perceive a mixed color formed by the red, green, and blue colors displayed from the pixels PX disposed adjacent to one another. For example, when a data signal for displaying the highest gradation is applied to each of the pixels PX displaying the red, green, and blue colors, and the pixels PX emit light, the red, green, and blue colors of high gradation output from the pixels PX may be mixed, and thus, a user may perceive a white light. Also, for example, when a data signal for displaying high gradation is applied to each of the pixels displaying red and green colors, and when a data signal for displaying low gradation is applied to the pixel displaying the blue color, the red, and green colors of high gradation output from the pixels are mixed with the blue color of low gradation, and thus, a user may perceive yellow light.

As shown in FIG. 1, the display panel 110 may be an organic light-emitting panel that operates by receiving the driving voltage ELVDD and the common voltage ELVSS. Each of the pixels PX included in the organic light-emitting panel includes an organic light-emitting diode. The display panel 110 may also be one of various types of panels including a self-light emitting diode. When the driving voltage ELVDD and the common voltage ELVSS are applied to the display panel 110, a current flows through the organic light-emitting diode, and thus, light is emitted therefrom.

The control unit 120 controls the data driver 130 and the scan driver 140. The control unit 120 generates signals SCS and DCS for controlling the data driver 130 and the scan driver 140 based on the image data DATA and a control signal received from the outside and provide the signals SCS and DCS to the data driver 130 and the scan driver 140. For example, the control signal CS is a timing signal, e.g., a vertical sync signal Vsync, a horizontal sync signal Hsync, a clock signal CLK, a data enable signal DE, and so forth, and the image data DATA may be a digital signal that indicates gradation of the light output from the pixels PX.

The control unit 120 may also receive the image data DATA from the outside and provide the image data DATA based on the control signal at a display timing to the data driver 130. Here, the control unit 120 may image process the image data DATA to improve display quality of the display panel 110 and provide the converted image data to the data driver 130. For example, a data value of the image data DATA may be scaled and a scaled image data SDATA may be provided to the data driver 130.

The data driver 130 receives the data control signal DCS and the scaled image data SDATA from the control unit 120, and provides a data signal corresponding to the scaled image data SDATA to the pixels PX through the data lines DL1 to DLm in response to the data control signal DCS.

The scan driver 140 receives the scan control signal SCS from the control unit 120 and generates a scan signal. Moreover, the scan driver 140 may provide the generated scan signal to the pixels PX through the scan lines SL1 to SLn. The pixels PX of each row are sequentially selected according to the scan signal to provide a data signal.

The power unit 150 generates and provides a driving voltage ELVDD and a common voltage ELVSS to the display panel 110. The driving voltage ELVDD and the common voltage ELVSS are commonly applied to the plurality of pixels PX of the display panel 110 to allow the pixels PX to emit light. A current flowing through the pixels PX when light is emitted according to values of the driving voltage ELVDD, and thus the common voltage ELVSS may be determined.

The display device 100 according to an embodiment of the present invention may include a data scaling unit 10. In FIG. 1, it is shown that the data scaling unit 10 is included in the control unit 120 in FIG. 1, however, embodiments are not limited thereto and the data scaling unit 10 may be separate from the control unit 120.

The data scaling unit 10 may output the scaled image data SDATA by scaling a data value of image data DATA received from the outside. The data scaling unit 10 may scale a data value of the image data DATA based on a scaling ratio that is predetermined or provided from the outside.

The power unit 150 may control the driving voltage ELVDD in response to the data scaling. The power unit 150 may increase the driving voltage ELVDD, for example, when a scaling ratio is less than 1. Accordingly, even when displayed gradation is reduced as the data scaling unit 10 down scales the image data DATA, a brightness of light before gradation changes, i.e., a brightness of light output in response to the image data DATA and a brightness of light output in response to the scaled image data SDATA may be the same by increasing the driving voltage ELVDD in response to the reduction of the displayed gradation.

For example, the image data DATA may be an 8 bit digital signal, a driving voltage ELVDD may be 5 V, and a data value of the image data DATA may be ‘11111111’ or a 256 gradation. That is, in an embodiment, it is assumed that a brightness of light output from the pixels PX of the display panel 110 for displaying the highest gradation is set to 150 nit or candela per square meter. In this case, when a scaling ratio is 0.5, and when the image data DATA is driven by data scaling based on the scaling ratio, a driving method is as follows. First, when the image data DATA displaying a 256 gradation is 0.5 times scaled based on the scaling ratio, a data value of the scaled image data SDATA may be displayed as ‘01111111’ or a 128 gradation. Brightness of light output before and after the data scaling is to be the same. When a digital driving method is used, brightness is determined depending on a light-emitting time and a value of the driving current. When the 256 gradation is displayed, a light-emitting time of the pixels PX is longer than a light-emitting time of the pixels PX of when the 128 gradation is displayed. Therefore, a value of a driving current of the 128 gradation after the data scaling needs to be increased to be higher than a value of a driving current of the 256 gradation before the data scaling in order to have the same brightness before and after the data scaling. The power unit 150 may increase a driving current by outputting a driving voltage ELVDD that is increased to be higher than 5 V, for example, 6 V. In this regard, a brightness of light output from the pixel PX in response to the scaled image data SDATA, i.e., the 128 gradation, may be 150 nit like before the scaling.

Since the brightness before and after the scaling is to be the same, the power unit 150 may further increase a driving voltage ELVDD as a scaling ratio is lower. In the example described above, when the scaling ratio is lowed to 0.25, the scaled image data SDATA generated by 0.25 times scaling the data value ‘11111111’ of the image data DATA may be displayed as ‘00111111’, or a 64 gradation. In this case, the driving voltage ELVDD may be increased to be higher than 6 V when a scaling ratio is 0.5 to allow a brightness of light output in response to the 64 gradation to be 150 nit.

Up to this point, the case of changing the driving voltage ELVDD based on a scaling ratio has been described, but embodiments are not limited thereto. Alternatively, a scaling ratio may be determined based on the driving voltage ELVDD. In other words, when the power unit 150 increases the driving voltage ELVDD, the data scaling unit 10 may accordingly scale a data value of image data DATA and output scaled image data SDATA. The data scaling unit 10 may scale a data value of the image data DATA to lower the gradation to make a brightness of light output from the display panel 110 to be the same as a brightness based on a driving voltage before the change.

As described above, the display device 100 according to an embodiment scales a data value of the image data DATA received from the outside, and in response, the driving voltage ELVDD may be controlled to drive the display device 100. Hereinafter, such a driving method is referred to as a data scaling driving method.

When the display device 100 is driven by the data scaling driving method, reduction of long range uniformity (LRU) may be prevented via a voltage drop of the driving voltage ELVDD occurring when the display panel 110 is driven, that is, an IR drop. The driving voltage ELVDD and the common voltage ELVSS are commonly provided to a plurality of pixels PX included in the display panel 110. When the pixels PX emit light, a voltage drop of the driving voltage ELVDD occurs as a massive amount of current flows from the driving voltage ELVDD to the common voltage ELVSS. In particular, a voltage drop increases as a resistance value of a voltage line providing the driving voltage ELVDD to each of the pixels PX increases. In this regard, the driving voltage ELVDD applied to pixels PX arranged at a location (e.g., point A) far from a point where the driving voltage ELVDD is applied from the power unit 150 is lowered than the driving voltage ELVDD applied to pixels PX arranged at a location (e.g., point B) near a point where the driving voltage ELVDD is applied from the power unit 150. In this regard, the driving voltage ELVDD applied to each of the pixels PX may have a deviation according to locations of the pixels PX arranged on the display panel 110. Consequently, even when each of the pixels PX displays the same gradation, a brightness of each of the pixels PX may be different, and thus, the LRU of the display panel 110 may be lowered. Particularly, when a size of the display panel 110 is large and the display device 100 used in a large-sized TV, a brightness deviation caused by a voltage drop of the driving voltage ELVDD may occur, and the LRU may be lowered.

However, the display device 100 according to an embodiment scales a data value of the image data DATA by using a data scaling driving method, and the driving voltage ELVDD may be controlled in response to the data scaling driving method, and thus, the LRU of the display panel 110 may be controlled. When brightness is maintained constant even when the driving voltage ELVDD increases, an amount of the voltage drop is almost similar to the amount of the voltage drop before the driving voltage ELVDD is increased. Since the driving voltage ELVDD increases, but the amount of the voltage drop, i.e., a deviation of the driving voltage ELVDD, does not increase, an effect of the amount of the voltage drop on the LRU decreases, and, thus, the LRU of the display panel 110 may increase.

Accordingly, when the display device 100 is driven by a data scaling driving method, the LRU of the display panel 110 may increase more than the case where the display device 100 is driven by a conventional driving method.

The display device 100 according to an embodiment may have an effect of improving the LRU of the display panel 110 without physical changes in the display panel 110 since the display device 100 is driven by a data scaling driving method.

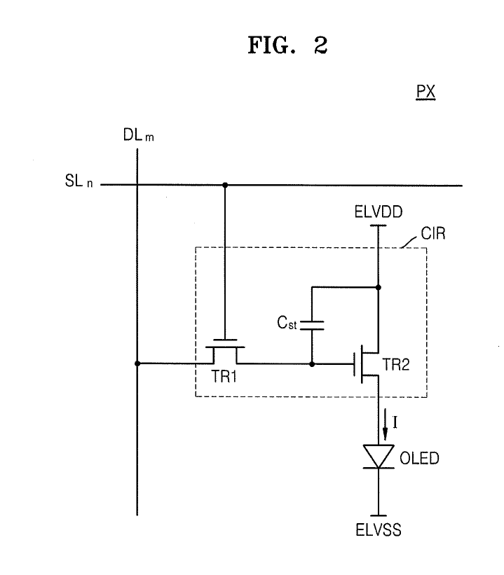

FIG. 2 illustrates a circuit diagram of an example of one of the plurality of pixels of FIG. 1. Particularly, a pixel in a case when the display device 100 is an organic light-emitting display device is illustrated. For convenience in description, a pixel connected to an m^{th} data line DLm and an n^{th} scan line SLn is illustrated.

Referring to FIG. 2, a pixel PX may include an organic light emitting diode (OLED) and a pixel circuit CIR supplying a current to the OLED. The pixel circuit CIR may include transistors TR1 and TR2 and a capacitor Cst. The transistors TR1 and TR2 may be thin film transistors (TFT). In FIG. 2, the pixel circuit CIR includes the two transistors TR1 and TR2 and the capacitor Cst, but embodiments are not limited thereto. The pixel circuit CIR may be formed in various types to supply a current corresponding to a data signal to the OLED.

An anode electrode of the OLED is connected to the pixel circuit CIR, and a cathode electrode of the OLED is connected to a common voltage ELVSS. The OLED generates light having a predetermined brightness in response to the current supplied from the pixel circuit CIR.

The pixel circuit CIR receives a data signal from the data line DLm when a scan signal is provided to the scan line SLn. When the scan signal is received by the pixel circuit CIR through the scan line SLn, the first transistor TR1 is turned on, and a data signal provided through the data line DLm is transferred to a gate terminal of the second transistor TR2. The data signal is a signal that controls turn-on/turn-off of the second transistor TR2. When the second transistor is turned on in response to the transferred data signal, the driving voltage ELVDD is applied to the anode electrode of the OLED, and thus, a current I flows through the OLED and the OLED emits light. A value of the current I may differ according to voltages applied to both ends of the OLED, i.e., values of the driving voltage ELVDD and the common voltage ELVSS. When the second transistor TR2 is turned off, the anode electrode of the OLED is in a floating state, and thus, the light emitted by the OLED starts dimming. The capacitor Cst stores charges corresponding to a difference between the driving voltage ELVDD and a voltage of the transferred data signal, thereby maintaining the turn-on or turn-off status of the second transistor TR2 even when the first transistor TR1 is turned off so that a data signal is not transmitted thereto.

A brightness of light output from the pixel PX is determined by a light-emitting time of the pixel, i.e., a light-emitting time of the OLED, and a value of the current I that flows through the OLED when the light is emitted. As the light-emitting time of the pixel PX in one frame period is long, and as the driving voltage ELVDD is high, a brightness of light output from the pixel PX increases.

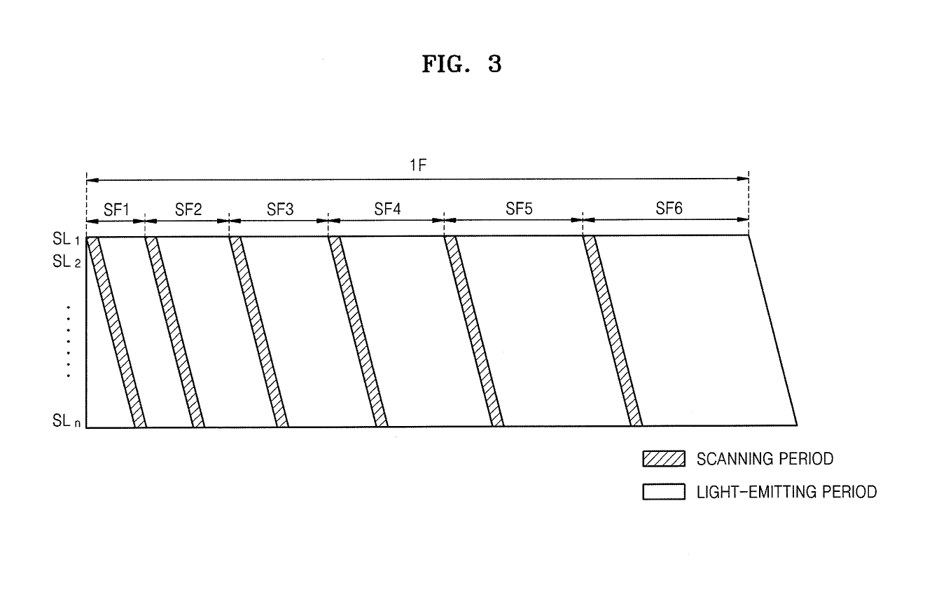

FIG. 3 illustrates a frame structural view of an example of a digital driving method. Referring to FIG. 3, one frame 1F may include a plurality of sub-fields SF1 to SF6. Each of the plurality of sub-fields SF1 to SF6 may be divided into a scanning period and a light-emitting period.

In the scanning period, a scan signal is sequentially supplied to the scan lines SL1 to SLn. When the scan signal is sequentially supplied, the pixels PX in a horizontal line unit are selected. A data signal is provided to the pixels PX by the scan signal.

In the light-emitting period, the pixels PX may or may not emit light in response to the provided data signal. In the light-emitting period, a time period per each of the subfields SF1 to SF6 may be set differently. The time period of the light-emitting period of each of the subfields SF1 to SF6 may be controlled to set a binary weight of the corresponding subfield.

For example, a binary weight of each subfield may be determined so as the binary weight increases in a ratio of 2ⁿ (n=0, 1, 2, 3, 4, 5) wherein a binary weight of a first subfield SF1 is set to 20, and a binary weight of a second subfield SF2 is set to 2¹. The frame having such structure may display an image in 64 (=2⁶) gradations in total. For example, when an image in 64 gradation is displayed, the subfields from the first subfield SF1 to the sixth subfield SF6 may be turned on. That is, the 64 gradation may be displayed by providing a data signal that turns on the light-emitting diode to a data line during each scanning period from the first subfield SF1 to the sixth subfield SF6 and emitting light of the light-emitting diode during the light-emitting period after an addressing period.

On the other hand, when the 10 gradation is displayed, a second subfield SF2 having a binary weight of 2 (=2¹) and a fourth subfield SF4 having a binary weight of 8 (=2³) may be turned on. That is, a data signal turning on the light-emitting diodes is supplied to a data line during each addressing period of the second and fourth subfields SF2 and SF4, and a data signal off the light-emitting diodes is supplied to a data line during each addressing period of the first, third, fifth, and sixth subfields SF1, SF3, SF5, and SF6. Therefore, the light-emitting diodes emit light during each light-emitting period of the second and fourth subfields SF2 and SF4, and the light-emitting diodes do not emit light during each light-emitting period of the rest of subfields, and thus, the 10 gradation may be displayed.

In this regard, a light-emitting time of the pixels PX during one frame period may be controlled to express gradation.

In FIG. 3, an example of one frame formed of six subfields is illustrated, but embodiments are not limited thereto, and a number of subfields forming one frame may vary. Also, FIG. 2 illustrates subfields arranged in an increasing order of a size of the binary weight, but the subfields may be arranged in a decreasing order of the binary weight in one frame or may be arranged regardless of the binary weight. In addition, various types of digital driving methods may be used to display an image in the display device according to embodiments.

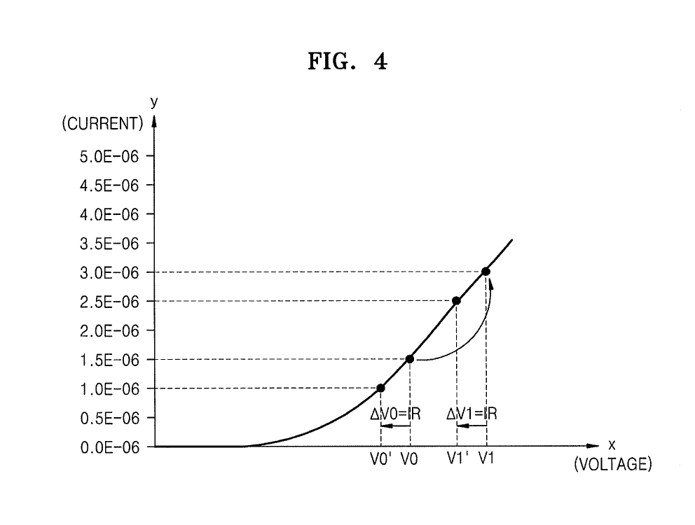

FIG. 4 illustrates a graph to describe LRU of the display device 100 of FIG. 1, the graph illustrating a relationship between a voltage and a current that are applied to the pixels PX.

An x-axis of the graph of FIG. 4 shows a voltage difference between the driving voltage ELVDD and the common voltage ELVSS applied to the pixels PX. For convenience of description, the common voltage ELVSS may be 0 V, and accordingly, voltages V0, V0′, V1, and V1′ on the x-axis may indicate values of the driving voltage ELVDD. Here, V0 is a value of the driving voltage ELVDD when the display device is driven by a conventional driving method, and V1 is a value of the driving voltage ELVDD when the display device is driven by a data scaling driving method. Each of V0′ and V1′ indicates a value of the driving voltages ELVDD that is voltage-dropped by IR drop.

A y-axis of the graph of FIG. 4 shows a value of a current that flows when the pixels PX emit light, i.e., a current I flowed through the OLED of FIG. 2. Here, particular values of the y-axis may differ depending on characteristics of the display panel (or the OLED). However, a relationship between the voltage and the current may be approximated, and thus, the relationship may be expressed by Equation 1.

y=f(x)=βx Equation 1

where, x is a value of the driving voltage ELVDD, y is a value of the driving current I applied to the pixels PX, and β is an approximate slope of the graph. As shown in the graph of FIG. 4, the relationship of the voltage and the current in the voltage interval between the voltage V1′ and voltage V1 may be assumed as approximating a linear function.

Also, the LRU may be calculated as a ratio of the lowest brightness with respect to the highest brightness, and a brightness may be expressed by Equation 2 since the brightness may vary according to a value of the driving current I.

LRU(x)=f(x′)/f(x)=f(x−IR)/f(x)=β(x−IR)/βx=(x−IR)/x Equation 2

where, x is a value of the driving voltage ELVDD, x′ is a voltage-dropped value of the driving voltage ELVDD, and IR is an amount of the voltage drop.

When the display panel 110 is driven by the conventional driving method, the driving voltage ELVDD is V0. When the display panel 110 displays a full white image of the highest brightness, a voltage drop of the driving voltage ELVDD may occur due to the IR drop. As a resistance value of a wiring line where the driving voltage ELVDD is provided is large, the voltage drop is also large. Thus, the driving voltage ELVDD applied to the pixels PX may have a deviation, and maximum ΔV0 of the deviation may occur. Accordingly, a value of the current I flowing through the OLED may be different for each of the pixels PX. In this case, the LRU may be calculated as a ratio of the lowest brightness with respect to the highest brightness. Since the brightness may vary according to a value of the driving current I, when a voltage value of the driving voltage ELVDD is V0, the LRU may be expressed by Equation 3 below based on Equation 2.

LRU(V0)=f(V0′)/f(V0)=f(V0−IR)/f(V0)=β(V0−IR)/βV0=(V0−IR)/V0 Equation 3

When the display device 100 is driven by the data scaling method, a value of the driving voltage ELVDD may be increased to V1 to increase a value of the driving current I, and thus, image data is scaled to display a full white image of the same brightness as before. For example, if a value of the driving voltage ELVDD is V0 and the 256 gradation is displayed in the conventional driving method, a value of the driving voltage ELVDD may be increased to V1 and a 128 gradation may be displayed in the data scaling driving method. In this case, a value of the driving current I when the value of the driving voltage ELVDD is increased to V1 may be approximately twice as large as a value of the driving current I when the value of the driving voltage is V0.

When the voltage drop of the driving voltage ELVDD occurs due to the IR drop, the driving voltage ELVDD applied to the pixels PX may have a deviation, and maximum ΔV1 of the deviation may occur. A brightness in this case may be the same with the brightness when the display device 100 is driven by the conventional driving method, and thus, an average current output from one frame of the display period is same with the conventional current. Thus, an amount of voltage drop IR may be the same with the conventional amount. In this case, the LRU may be expressed by Equation 4.

LRU(V1)=f(V1′)/f(V1)=f(V1−IR)/f(V1)=β(V1−IR)/βV1=(V1−IR)/V1 Equation 4

Also, since V1 is α*V0 (α>1), when α*V0 replaces V1, a LRU may be finally expressed by Equation 5.

LRU(V1)=(α*V0−IR)/α*V0=(V0−IR/α)/V0 Equation 5

When Equation 3 expressing the LRU (LRU(V0)) according to the conventional driving method and Equation 5 expressing the LRU (LRU(V1)) according to the data scaling method are compared, the LRU according to the data scaling driving method is greater than the LRU according to the conventional driving method since α is greater than 1. Also, it may be confirmed that when a increases, the LRU increases accordingly.

Thus, when the display device 100 is driven by the data scaling driving method, the LRU may increase. However, α may be inversely proportional to a data scaling ratio since an increasing amount of the value of the driving voltage ELVDD needs to be increased as the data scaling ratio decreases. Therefore, a degree of improving the LRU may be adjusted by controlling the data scaling ratio.

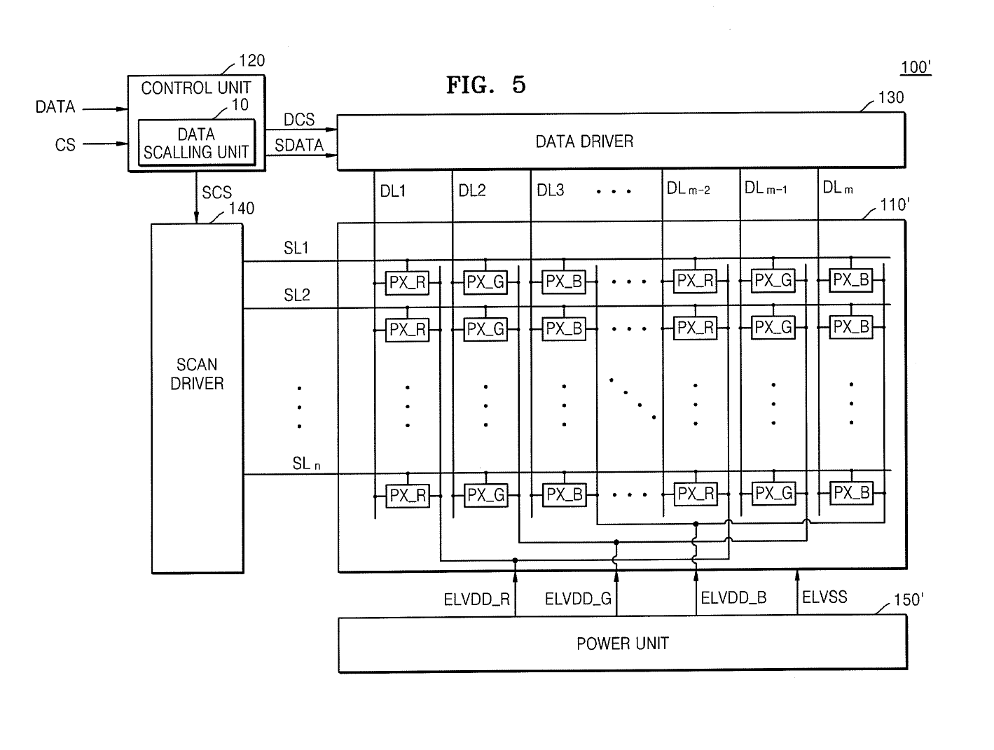

FIG. 5 illustrates a block diagram of a display device 100′ according to another embodiment. Referring to FIG. 5, the display device 100′ may include a display panel 110′, the scan driver 140, the data driver 130, and the control unit 120. Also, the display device 100′ may further include a power unit 150′.

In the display device 100′ of FIG. 5, the display panel 110′ includes red pixels PX_Rs, green pixels PX_Gs, and blue pixels PX_Bs. The power unit 150′ generates a first driving voltage ELVDD_R, a second driving voltage ELVDD_G, a third driving voltage ELVDD_B, and a common voltage ELVSS, and provides them to the display panel 110′. The common voltage ELVSS is a smaller than the first, second, and third driving voltages ELVDD_R, ELVDD_G, and ELVDD_B, and may be, for example, a ground voltage. The common voltage ELVSS may be commonly applied to the red pixels PX_Rs, the green pixels PX_Gs, and the blue pixels PX_Bs. The first driving voltage ELVDD_R is applied to the red pixels PX_Rs, the second driving voltage ELVDD_G is applied to the green pixels PX_Gs, and the third driving voltage is applied to the blue pixels PX_Bs. The first, second, and third driving voltages ELVDD_R, ELVDD_G, and ELVDD_B may be set to be the same or different from one another.

Like in the case of the display device 100 of FIG. 1, a data scaling driving method is used to the display device 100′ of FIG. 5. A data scaling unit 10 scales a data value of received image data DATA to provide scaled image data SDATA to a data driver 130, and the driving voltages ELVDD_R, ELVDD_G, and ELVDD_B may be controlled according to the data scaling of the power unit 150′. Here, white balance of the display panel according to the first, second, and third driving voltages ELVDD_R, ELVDD_G, and ELVDD_B needs to be considered as well. Accordingly, increased amounts of the first, second, and third driving voltages ELVDD_R, ELVDD_G, and ELVDD_B may be different from one another.

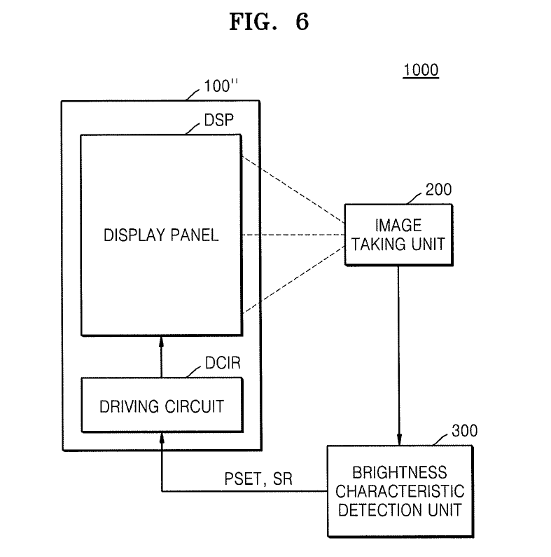

FIG. 6 illustrates a block diagram of a brightness compensation system 1000 of a display device according to another embodiment.

The brightness compensation system 1000 of FIG. 6 is a brightness compensation system for compensating the LRU of a display device 100″. The brightness compensation system 1000 may include the display device 100″, an imaging unit 200, and a brightness characteristic detecting unit 300.

The display device 100″ may be the display device 100 of FIG. 1 or 100′ of FIG. 5, and may include a display panel DSP displaying an image and a display driving circuit DCIR for driving the display panel DSP. The driving circuit DCIR may include the control unit 120, the data driver 130, the scan driver 140, and the power unit 150 or 150′ illustrated in FIG. 1 or FIG. 5.

An image taking unit 200 may take an image displayed on the display panel. The image taking unit 200 may include a camera, a scanner, a photosensor, or a spectrometer. The image taking unit 200 is shown as being located outside of the display device 100, but the present embodiment is not limited thereto, and the image taking unit 200 may be included in the display device 100″.

A brightness characteristic detection unit 300 detects brightness characteristics of the display device 100″, and conditions for improving the brightness characteristics of the display device 100″ may be set based on the detected result. Particularly, control signals SR and PSET for controlling the display device 100″ may be provided by a driving circuit DCIR of the display device 100 in order to derive the LRU of the display device 100″ and compensate the LRU.

In particular, the brightness characteristic detection unit 300 derives the LRU of the display device 100″ by analyzing brightness data obtained from a display image captured by the image taking unit 200. The display image may be a full white image of the highest brightness. Generally, when a full white image of the highest brightness is displayed on the display panel DSP, a brightness of each pixel may significantly differ from one another. Therefore, a full white image of the highest brightness is displayed on the display panel DSP in order to derive the LRU under the worst conditions, and the LRU is calculated. The LRU may be calculated as a ratio of the lowest brightness with respect to the highest brightness.

When the derived LRU is less than a predetermined value, the brightness characteristic detection unit 300 may generate and provide the control signals SR and PET for improving the LRU to the display device 100″. The brightness characteristic detection unit 300 may provide a scaling control signal SR and a driving voltage control signal PSET to the driving circuit DCIR to derive a scaling ratio for data scaling and a voltage value of a driving voltage and to provide information about the scaling ratio and the voltage value of the driving voltage to the driving circuit DCIR. The scaling control signal SR may be transmitted to the data scaling unit 10 of FIG. 1 or FIG. 5, and the driving voltage control signal may be provided to the power unit 150 of FIG. 1 or 150′ of FIG. 5. The data scaling unit 10 scales a data value of the image data DATA in response to the scaling control signal SR, and the power unit 150 or 150′ may control a voltage value of the driving voltage ELVDD in response to the driving voltage control signal PSET.

The brightness characteristic detection unit 300 is illustrated as providing the scaling control signal SR and the driving voltage control signal PSET to the driving circuit DCIR in FIG. 6, but the present embodiment is not limited thereto. The brightness characteristic detection unit 300 may provide only the scaling control signal SR, and the power unit may control a voltage value of the driving voltage ELVDD based on the scaling ratio. Alternatively, the brightness characteristic detection unit 300 may provide only the driving voltage control signal PSET, and the data scaling unit 10 may derive a scaling ratio based on the voltage value of the driving voltage ELVDD and perform data scaling based on the scaling ratio.

The display device 100″ may set a scaling ratio and a voltage value of the driving voltage ELVDD in response to the scaling control signal SR and the driving voltage control signal PSET, and, when the image data DATA is received from the outside, the display device 100″ may be driven by the data scaling driving method. As the display device 100 is driven by the data scaling driving method, the LRU may increase.

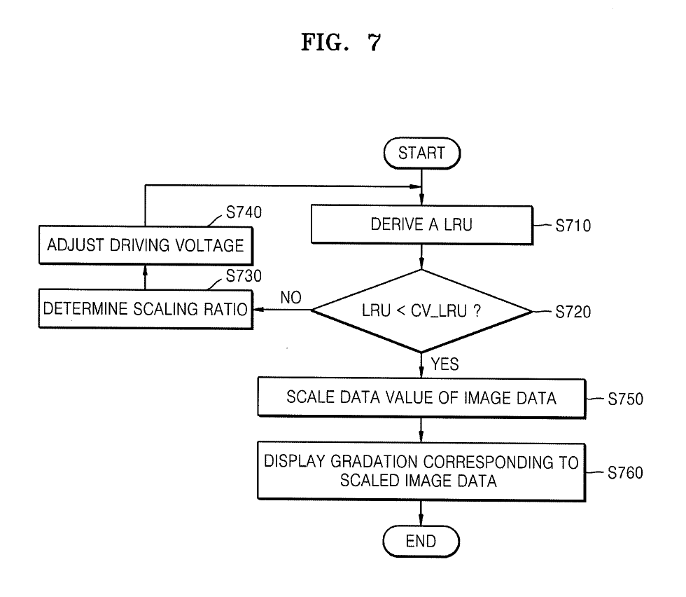

FIG. 7 illustrates a flowchart for describing a driving method of a display device 100 according to an embodiment.

In an initial operation or a testing operation, a driving condition of the display device 100 may be set so as the LRU of a display panel 110 may be equal to a predetermined value or greater, and thus, the display device 100 may be driven by a data scaling method.

In this regard, first, the LRU of the display panel 110 may be derived (S710). A test image, for example, a full white image of the highest gradation, is displayed on the display panel 110. The image taking unit 200 detects a brightness data per pixel from the obtained image that is taken from the display panel 110. Also, the LRU may be derived based on the brightness data per pixel.

Once the LRU is derived, whether the driven LRU is at least equal to the predetermined value or not is determined (S720). The predetermined value may be a critical value CV_LRU for determining whether the display device 100 is defective or not.

When the LRU is at least equal to the predetermined value, LRU improvement is not needed, and thus, the display device 100 may be driven by a conventional driving method. However, when the LRU is less than the predetermined value, LRU improvement is needed, and thus, a process of searching for a driving condition to increase the LRU up to at least the predetermined value may be performed.

In this regard, first, a scaling ratio based on a LRU may be determined (S730). The scaling ration may be set to be less than 1 since an image data needs to be downscaled and a voltage value of the driving voltage ELVDD needs to be increased in order to improve the LRU. Here, as the scaling ratio is lower, a range of improvement of the LRU may further increase. Thus, when the scaling ratio is controlled, a degree of the LRU improvement may be controlled.

The driving voltage is adjusted based on the determined scaling ratio (S740). As the scaling ratio decreases, the driving voltage may increase. Meanwhile, as described in FIG. 5, when the power unit 150′ generates and provides a plurality of driving voltages to the corresponding pixels among pixels that emit different light colors, each driving voltage may be individually adjusted.

Then, the display device 100 is driven by the data scaling driving method based on the scaling ratio and the voltage value of the driving voltage set in the scaling ratio setting operation (S730) and the driving voltage adjusting operation (S740), and thus a LRU may be re-derived (S710). Whether the re-driven LRU is at least equal to the predetermined value or not is determined (S720).

When the LRU is at least equal to the predetermined value, the display device 100 performs data scaling of a data value of an image data received from outside based on the scaling ratio (S750), and a gradation corresponding to the scaled image data is displayed (S760). That is, the display device 100 may be driven by the data scaling driving method based on the set scaling ratio and the voltage value of the driving voltage.

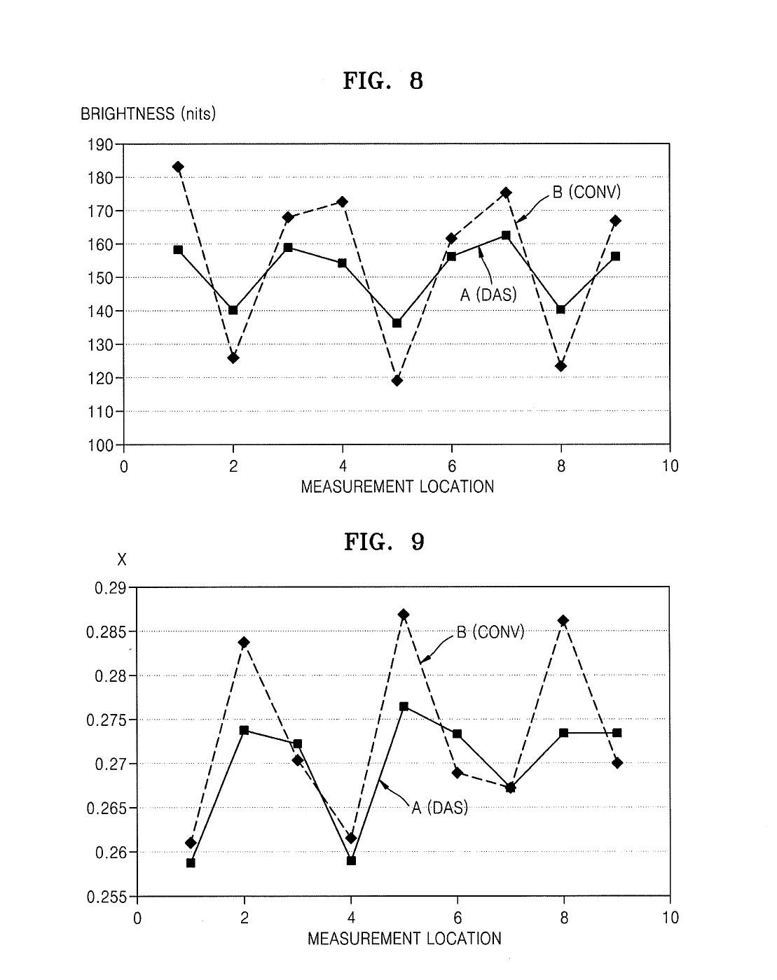

FIGS. 8 and 9 illustrate graphs for comparing the characteristics of a display device according to an embodiment and a conventional display device. FIG. 8 is a graph showing brightness characteristics and FIG. 9 is a graph showing color characteristics.

In FIGS. 8 and 9, a solid line A (DAS) indicates a brightness value and an x color coordinate according to a measurement location of a driving device according to an embodiment of the present invention that is driven by a data scaling driving method, and a dashed line B (CONV) indicates a brightness value and an x color coordinate per a measurement location of a conventional driving device, that is when the data scaling driving method is not used. As shown in FIGS. 8 and 9, a brightness deviation and a color deviation are reduced when the data scaling driving method is used. In this regard, the display device according to an embodiment of the present invention driven by the data scaling method has an improved image quality than the conventional display device.

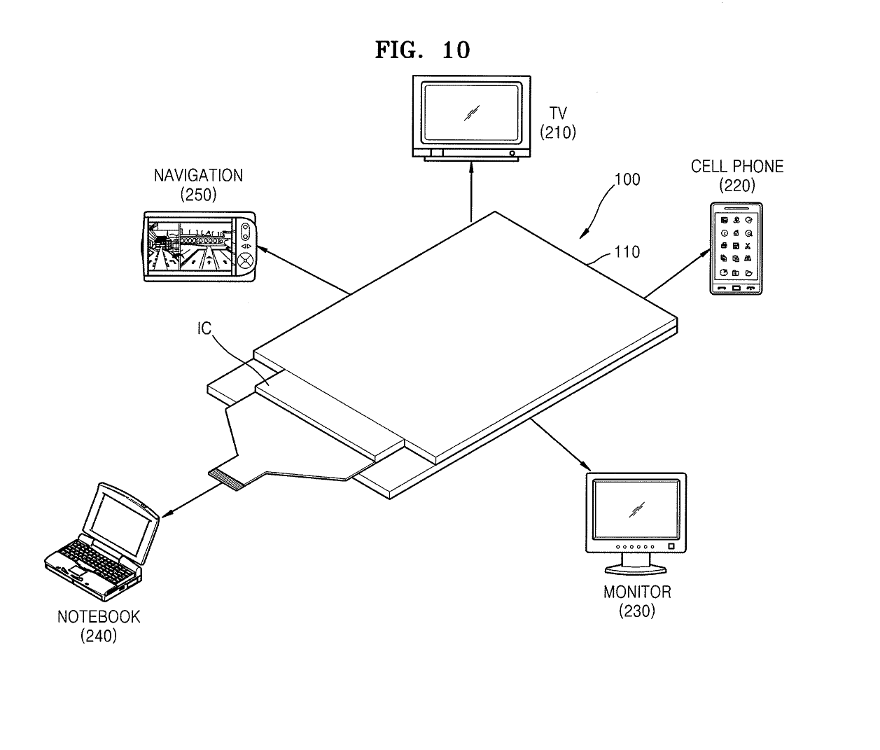

The display device according to embodiments may be used in various electronic products, as illustrated in FIG. 10. For example, the display device according to embodiments may be widely used in a cell phone, a monitor, a laptop, a navigator, and so forth, as well as in a TV.

According to one or more embodiments, a display device may control the LRU of a display panel by scaling a data value of image data received from the outside and controlling a driving voltage applied in common to pixels.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display device, comprising:
a display panel including a plurality of pixels;
a data scaling unit scaling a data value of image data received from an outside based on a scaling ratio;
a data driver providing a data signal to data lines connected to the plurality of pixels in response to the scaled data value; and
a power unit that generates a driving voltage for making the plurality of pixels emit light and that changes the driving voltage based on the scaling ratio.

2. The display device as claimed in claim 1, wherein a long range uniformity (LRU) of the display panel is adjusted according to the scaling ratio.

3. The display device as claimed in claim 2, wherein the scaling ratio is set based on the LRU of the display panel in a test period of the display device when the display panel displays the highest gradation.

4. The display device as claimed in claim 2, wherein the scaling ratio is set to be less than 1 when the LRU is lower than a predetermined value.

5. The display device as claimed in claim 1, wherein the data scaling unit down scales the data value of the image data received from the outside.

6. The display device as claimed in claim 1, wherein, when the driving voltage is changed, the data scaling unit scales the data value of the image data received from the outside to have the same brightness with a brightness that is set based on a level of the driving voltage before the brightness of light output from the display panel is changed.

7. The display device as claimed in claim 1, wherein the power unit increases or decreases the driving voltage based on the scaling ratio.

8. The display device as claimed in claim 1, wherein the power unit increases the driving voltage when the scaling ratio is less than 1.

9. The display device as claimed in claim 1, wherein the power unit further increases the driving voltage as the scaling ratio decreases.

10. The display device as claimed in claim 1, wherein the display panel is driven by a digital driving method, whereby a brightness of output light is changed depending on the driving voltage and a light-emitting time according to a data signal applied to each of the plurality of pixels.

11. The display device as claimed in claim 1, wherein each of the plurality of pixels comprises an organic light-emitting diode.

12. A display device, comprising:
an organic light-emitting display panel comprising a plurality of pixels comprising first pixels, second pixels, and third pixels emitting lights of different colors, and data lines and scan lines that are connected to the plurality of pixels;
a scan driver sequentially providing a scan signal to the scan lines in each scan period of a plurality of sub-frames comprised in one frame;
a data scaling unit that scales a data value of image data received from the outside based on a scaling ratio;
a data driver providing a data signal that is generated by using the scaled data value to the data lines; and
a power unit generating a first driving voltage, a second driving voltage, and a third driving voltage that are each respectively provided to the first pixels, the second pixels, and the third pixels and adjusting at least one of the first driving voltage, the second driving voltage, and the third driving voltage based on the scaling ratio.

13. The display device as claimed in claim 12, wherein the data scaling unit downscales the data value of the image data received from the outside, and the power unit increases at least one of the first, second, and third driving voltages based on the scaling ratio.

14. The display device as claimed in claim 13, wherein the power unit further increases at least one of the first, second, and third driving voltage as the scaling ratio is lower.

15. The display device as claimed in claim 12, wherein the first pixels are pixels that emit red light, the second pixels are pixels that emit green light, and the third pixels are pixels that emit blue light.

16. A method of driving a display device comprising a plurality of pixels, the method comprising:
deriving a LRU of a display panel;
determining a scaling ratio based on the LRU;
adjusting a driving voltage according to the scaling ratio;
scaling a data value of image data received from the outside based on the scaling ratio; and
displaying a gradation corresponding to the scaled image data.

17. The method as claimed in claim 16, wherein deriving the LRU comprises deriving the LRU based on a brightness data per pixel when a full white image of the highest brightness is displayed on the display panel.

18. The method as claimed in claim 16, wherein scaling the data value comprises increasing the voltage value of the driving voltage as the scaling ratio decreases.

19. The method as claimed in claim 16, wherein the plurality of pixels includes red pixels, green pixels, and blue pixels, wherein the driving voltage includes a first driving voltage applied to the red pixels, a second driving voltage applied to the green pixels, and a third driving voltage applied to the blue pixels, and wherein adjusting the driving voltage includes adjusting each of the first, second, and third driving voltages based on the scaling ratio.

20. The method as claimed in claim 16, wherein the display panel is driven by a digital driving method whereby a brightness of output light is changed according to the driving voltage and an emission time in response to a data signal that is transmitted to each of the plurality of pixels.
